(19) United States
(12) Patent Application Publication
(10) Pub. No.: US 2023/0278536 A1
(43) Pub. Date: Sep. 7, 2023

(54) BRAKE-SHIFT INTEGRATED SYSTEM FOR WIRE-CONTROLLED VEHICLES BASED ON MACHINE-HYDRAULIC COMPOUND AND CONTROL METHOD THEREOF

(71) Applicant: JIANGSU UNIVERSITY, Zhenjiang (CN)

(72) Inventors: Feng WANG, Zhenjiang (CN); Xing XU, Zhenjiang (CN); Hao WANG, Zhenjiang (CN); Jian ZHANG, Zhenjiang (CN)

(73) Assignee: JIANGSU UNIVERSITY, Zhenjiang (CN)

(21) Appl. No.: 18/012,987

(22) PCT Filed: Mar. 23, 2021
(86) PCT No.: PCT/CN2021/082324

§ 371 Date: Dec. 27, 2022

(30) Foreign Application Priority Data
Feb. 22, 2021 (CN) 202110195942.X

(51) Int. Cl. B60T 13/74; B60T 17/22; B60T 7/06; F16H 61/02; F16H 63/32; F16H 61/32

(52) U.S. Cl. CPC B60T 13/745; B60T 7/06; B60T 17/22; F16H 61/32; F16H 61/0204; F16H 63/32

(57) ABSTRACT

A brake-shift integrated system for wire-controlled vehicles based on machine-hydraulic compound and a control method thereof are provided. The brake-shift integrated system includes a shift module, a brake-by-wire module, a power distribution module and a control assembly module. The shift module includes a shift booster sub-module and a shift actuator sub-module. The shift booster sub-module is used to store and reuse the braking force to assist the shift. The shift actuator sub-module is used to implement mechanical automatic gearshift. The brake-by-wire module is used to implement the brake-by-wire process. The power distribution module is used for motor torque distribution. The control assembly module reads the shift signal, brake signal and current signal from each motor controller to control the operation of the shift motor and brake motor, the locking and releasing of the brake and the opening and closing of the solenoid valve.

### CROSS REFERENCE TO THE RELATED APPLICATIONS

This application is the national phase entry of International Application No. PCT/CN2021/082324, filed on Mar. 23, 2021, which is based upon and claims priority to Chinese Patent Application No. 202110195942.X, filed on Feb. 22, 2021, the entire contents of which are incorporated herein by reference.

### TECHNICAL FIELD

The present disclosure relates to the field of automotive technology, and in particular to a brake-shift integrated system for wire-controlled vehicles based on machine-hydraulic compound and a control method thereof.

### BACKGROUND

Compared to traditional vehicles, wire-controlled vehicles have become the focus of research in the automotive industry with brake-by-wire technology and shift-by-wire technology are of particular interest.

Brake-by-wire system comprises an electro-mechanical braking system and an electro-hydraulic braking system. The electro-hydraulic braking system combines an electronic system with a hydraulic system. This leads to a reliability problem. Once the brake motor is faulty seriously, it will directly affect the braking performance of the vehicle, and may lead to serious traffic accidents. The control of electro-mechanical braking system is precise and rapid. However, the braking force is not fully utilized. And the structure of the brake-by-wire system is complex because of the current optimization.

The transmission is an important part of the drive system whose control performance directly affects the success and quality of the shift. Nevertheless, in the shift process of the two-speed mechanical automatic transmission for electric vehicles there is an active synchronization phase. The shift execution motor inevitably starts during the whole shift process. The shift fork accelerates, decelerates, re-accelerates and re-decelerates, and it makes control difficult, while affects performance of gear shift and service life of shift motor.

### SUMMARY

In response to the deficiencies in the prior art, the present disclosure provides a brake-shift integrated system for wire-controlled vehicles based on machine-hydraulic compound and a control method thereof, using a shift guide rail and a shift booster mechanism for shift execution, a solenoid valve set for braking force adjustment, a planetary gear for motor torque distribution, and in the event of a failure of one motor, the other motor achieves the function of both shifting and braking to increase the stability and reliability of the shift system and brake system.

The present disclosure achieves the above technical purposes by means of the following technical solutions.

The brake-shift integrated system based on machine-hydraulic compound, characterized by comprising a shift module, a brake-by-wire module, a power distribution module and a control assembly module.

The shift module comprises a shift booster sub-module and a shift actuator sub-module. The shift booster sub-module comprises a brake pedal and a brake piston cylinder. The brake piston cylinder is connected to the brake pedal, and a tail end of the brake piston cylinder is in communication with two hydraulic lines. A first hydraulic line is in one-way communication with an oil storage cylinder, and a second hydraulic line is in one-way communication with a high-pressure accumulator. The high-pressure accumulator is in communication with a shift booster mechanism through a hydraulic line, and the shift booster mechanism is in communication with the oil storage cylinder through a hydraulic line. The shift booster mechanism is connected to the power distribution module. The shift actuator sub-module comprises a shift motor, a shift guide and a shift fork. The shift guide is connected to the shift fork and the power distribution module which is connected to the shift motor.

The power distribution module is connected to the brake motor in brake-by-wire module.

The control assembly module comprises an electronic control unit, which is in signal connected to a brake pedal angle sensor, a shift motor controller and a brake motor controller.

In the above technical solutions, the shift booster mechanism is provided with interconnected the first cavity and the second cavity. The first cavity is provided with a valve body, and the second cavity is provided with a shift booster piston, while the first cavity is provided with three channels at the upper end and two channels at the lower end. The upper three channels generate a high-pressure oil circuit and a low-pressure circuit at the left and right ends, while the high-pressure oil circuit is in communication with a high-pressure accumulator, and the low-pressure circuit at the left and right ends are in communication with an oil storage cylinder. The two channels at the lower end are connected to the two shift booster cylinders in the second cavity. The valve body and shift booster piston are both fixed to the shift fork.

In the above technical solutions, the shift guide rail surface is provided with a high gear rail groove, a shift rail groove and a low gear rail groove. The shift rail groove is connected to the high gear rail groove and the low gear rail groove by two sloping grooves at each end, and the connection is provided with a shift guide mechanism. The shift guide mechanism comprises a baffle and a reset spring, while the baffle is connected to the shift guide rail and the bottom end is restrained by the reset spring.

In the above technical solutions, the brake-by-wire module comprises a brake motor, a screw rod, a nut, a brake piston, a brake master cylinder and a solenoid valve group. The brake motor is fixed to one end of the screw rod, and the other end of the screw rod is connected to one end of the nut. The other end of the nut is connected to one end of the brake piston. The other end of the brake piston is connected to one end of the brake master cylinder. The other end of the brake master cylinder is connected to the solenoid valve group. The solenoid valve group comprises a booster solenoid valve, an unloading solenoid valve and a brake wheel cylinder.

In the above technical solutions, the power distribution module comprises a gear ring, a planetary carrier, a sun wheel, a first brake and a second brake. The planetary carrier is connected to the gearbox case via the first brake and to the gear ring via the second brake, while the gear ring is connected to the gearshift motor. The planetary carrier is also connected to the solar wheel which is connected to the brake motor.

The control method of the brake-shift integrated system based on machine-hydraulic comprises the following steps:
S1, detecting whether the brake motor is faulty, if the brake motor is not faulty, the system starts S2; if the brake motor is faulty, the system starts S6, and the shift motor will power braking;
S2, detecting whether the shift motor is faulty, if the shift motor is not faulty, the system starts S3; if the shift motor is faulty, the system starts S7, and the brake motor will power shifting;
S3, detecting whether to perform a brake, if the brake will be performed, the system starts S4; if the brake will not be performed, the system starts S9;
S4, detecting whether to perform a shift, if the shift will be performed, the system performs a regular shift and a regular brake and then starts S8; if the shift will not be performed, the system performs a regular brake and then starts S8;
S5, detecting whether to perform a shift, if the shift will be performed, the system performs a regular shift and then starts S8; if the shift will not be performed, the system does not act and then starts S8;
S6, starting the redundant brake mode, wherein the shift and brake functions are performed simultaneously by the shift motor and then the system starts S8;
S7, starting the redundant shift mode, wherein the shift and brake functions are performed simultaneously by the brake motor and then the system starts S8;
S8, feeding back the operating status signals of the shift motor and the brake motor to the electronic control unit for control.

Further, the redundant brake mode comprises the following operating states:

The first state is that the brake will not be performed with gear being in high, and the shift motor performs a regular downshift.

The second state is that the brake will not be performed with gear being in low, and the shift motor performs a regular upshift.

The third state is that the shift motor performs a redundant brake to unload by forward rotation with gear being in high.

The fourth state is that the shift motor performs a redundant brake to boost by forward rotation with gear being in high.

The fifth state is that the shift motor performs a redundant brake to unload by reverse rotation with gear being in low.

The sixth state is that the shift motor performs a redundant brake to boost by reverse rotation with gear being in low.

The seventh state is that the shift motor performs a redundant brake to unload by reverse rotation with gear being in high.

The eighth state is that the shift motor performs a redundant brake to boost by reverse rotation with gear being in high.

The ninth state is that the shift motor performs a redundant brake to unload by forward rotation with gear being in low.

The tenth state is that the shift motor performs a redundant brake to boost by forward rotation with gear being in low.

Further, the redundant brake mode comprises the following cases.

The first case is that the brake motor performs a regular brake to unload, and the gear has no effect on system control.

The second case is that the brake motor performs a regular brake to boost, and the gear has no effect on system control.

The third case is that the brake motor performs a redundant shift to downshift, and the gear has no effect on system control.

The fourth case is that the brake motor performs a redundant shift to upshift, and the gear has no effect on system control.

The fifth case is that the brake motor performs a regular brake to unload and a redundant shift to downshift, and the gear has no effect on system control.

The sixth case is that the brake motor performs a regular brake to unload and a redundant shift to upshift, and the gear has no effect on system control.

The seventh case is that the brake motor performs a regular brake to boost and a redundant shift to downshift, and the gear has no effect on system control.

The eighth case is that the brake motor performs a regular brake to boost and a redundant shift to upshift, and the gear has no effect on system control.

The present disclosure has the following beneficial effects.

In the event of a failure of one motor, the present disclosure can achieve the function of both shifting and braking by the other motor through the opening and closing of the solenoid valve set, the locking and releasing of the first brake and the second brake, and the operation of the shift guide rail and shift booster mechanism, with redundant protection, greatly improving the reliability and safety of the system.

By means of the designed shift guide rail, the shift actuator motor realizes the shift without frequent start to synchronize the speed of the motor with the bonding sleeve in the present disclosure. This improves the response speed of the system thus making the control easy and increase the service life of the shift motor.

By means of the designed shift booster mechanism, the present disclosure stores and reuses the force imposed on the pedal by driver during the brake-by-wire operation, and boosts the shift fork during the shift process to provide sufficient shift force to enable the shift process to proceed quickly and steadily to prevent the phenomenon of gear loss due to insufficient shift force. Meanwhile, the brake pedal shift boost module provides the driver with road sensation during the brake-by-wire operation.

### BRIEF DESCRIPTION OF THE DRAWINGS

FIG. 1 illustrates a schematic diagram of the structure of the brake-shift integrated system based on machine-hydraulic compound described in the present disclosure.

FIG. 2 illustrates a schematic diagram of the structure of the shift booster mechanism described in the present disclosure.

FIG. 3 illustrates a schematic diagram of the hydraulic flow during the rightward shift assist of the shift booster mechanism described in the present disclosure.

FIG. 4 illustrates a schematic diagram of the hydraulic flow during the leftward shift assist of the shift booster mechanism described in the present disclosure.

FIG. 5 illustrates a schematic diagram of the structure of the shift guide rail described in the present disclosure.

FIG. 6 illustrates a partially enlarged axonometric view of the gear shift guide mechanism described in the present disclosure.

FIG. 7 illustrates the movement of the fork in the shift guide rail when the present disclosure is in high gear described in the present disclosure.

FIG. 8 illustrates the movement of the fork in the shift guide rail when shifting from high to low gear described in the present disclosure.

FIG. 9 illustrates the movement of the fork in the shift guide rail when the it is in low gear described in the present disclosure.

FIG. 10 illustrates the control flow diagram of the brake-shift integrated system based on machine-hydraulic compound described in the present disclosure.

FIG. 11 illustrates the control flow diagram of the redundant brake mode performed by the shift motor described in the present disclosure.

FIG. 12 illustrates a control flow diagram of the redundant shift mode performed by the brake motor described in the present disclosure.

In the figures: 1. brake pedal, 2. brake piston cylinder, 3. first check valve, 4. second check valve, 5. oil storage cylinder, 6. relief valve, 7. high-pressure accumulator, 8. oil pressure gauge, 9. shift booster mechanism, 10. shift guide rail, 11. shift fork, 12. gear ring, 13. shift motor, 14. planetary frame, 15. first brake, 16. second brake, 17. solar wheel, 18. brake motor, 19. nut, 20. screw, 21. brake piston, 22. brake master cylinder, 23. solenoid valve set, 24. brake pedal angle sensor, 25. shift motor controller, 26. brake motor controller, 27. electronic control unit, 901. high-pressure oil circuit, 902. left low-pressure circuit, 903. right low-pressure circuit, 904. valve body, 905. shift booster left cylinder, 906. shift booster right cylinder, 907. shift booster piston, 1001. high gear rail groove, 1002. shift rail groove, 1003. low gear rail groove, 1004. shift guide mechanism, 1005. baffle, 1006. hinge, 1007. sector groove, 1008. reset spring.

### DETAILED DESCRIPTION OF THE EMBODIMENTS

The present disclosure is further described below in connection with the accompanying drawings and specific example, but the scope of protection of the present disclosure is not limited thereto.

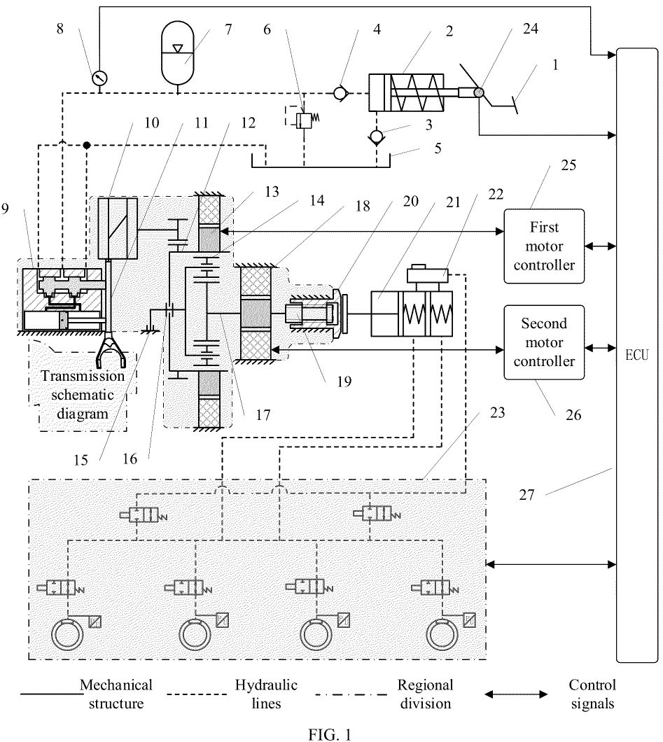

FIG. 1 shows the brake-shift integrated system based on machine-hydraulic compound which is composed of a shift module, a brake-by-wire module, a power distribution module and a control assembly module.

The shift module comprises a shift booster sub-module and a shift actuator sub-module to increase the stability and reliability of the mechanical automatic gearshift.

The shift booster sub-module comprises the brake pedal 1, the brake piston cylinder 2, the first check valve 3, the second check valve 4, the oil storage cylinder 5, the relief valve 6, the high-pressure accumulator 7, the oil pressure gauge 8 and the shift booster mechanism 9 to store and reuse the force imposed on the pedal 1 by driver and provide the driver with road sensation during the brake-by-wire operation.

The brake piston cylinder 2 is connected to the brake pedal 1, and the end of the brake piston cylinder 2 is in communication with two hydraulic lines, while the brake piston cylinder 2 is fitted with a spring to reset the brake pedal 1. The brake pedal 1 receives the braking force from the driver and transfers the torque to the brake piston cylinder 2, which converts the force imposed on the pedal 1 by driver into pressure in the hydraulic lines. The first check valve 3 is in communication with the oil storage cylinder 5 via one of the hydraulic line inputs, and the output of which is in communication with the brake piston cylinder 2. The first check valve 3 allows the hydraulic fluid to flow only from the oil storage cylinder 5 to the brake piston cylinder 2 and not in the opposite direction. The second check valve 4 is in communication with the brake piston cylinder 2 via another hydraulic line input, and the output of which is in communication with the high-pressure accumulator 7. The second check valve 4 allows the hydraulic fluid to flow only from the brake piston cylinder 2 to the high-pressure accumulator 7 and not in the opposite direction. The high-pressure accumulator 7 is arranged in the hydraulic line between the second check valve 4 and the shift booster mechanism 9 and is used to store the high-pressure hydraulic fluid. The relief valve 6 is arranged in the hydraulic line between the second check valve 4 and the high-pressure accumulator 7 for releasing the hydraulic oil to the oil storage cylinder 5 when the hydraulic line pressure reaches a threshold value, to ensure that the pressure in the hydraulic line is within the safe range under continuous braking in particular to protect the reliability of the high-pressure accumulator 7 The oil pressure gauge 8 is arranged in the hydraulic line between the high-pressure accumulator 7 and the shift booster mechanism 9 to detect the oil pressure in the hydraulic line and to transmit the oil pressure information of the shift booster sub-module to the control assembly module.

The working principle of the shift booster sub-module is as follows. Under the joint action of the first check valve 3 and the second check valve 4, when the driver steps on the brake pedal 1, the brake pedal 1 pushes the piston of the brake piston cylinder 2, compressing the hydraulic oil in the hydraulic line. As the hydraulic oil cannot flow to the oil storage cylinder 5 through the first check valve 3, the hydraulic oil in the hydraulic line flows from the brake piston cylinder 2 to the high-pressure accumulator 7 through the second check valve 4, and the high-pressure accumulator 7 starts to store energy, storing the force imposed on the pedal 1 by driver as hydraulic energy. When the driver releases the brake pedal 1 and the piston of the brake piston cylinder 2 is reset, the pressure in the brake piston cylinder 2 decreases and the hydraulic oil flows from the oil storage cylinder 5 to the brake piston cylinder 2 through the first check valve 3, and the pressure in the brake piston cylinder 2 is restored to equilibrium.

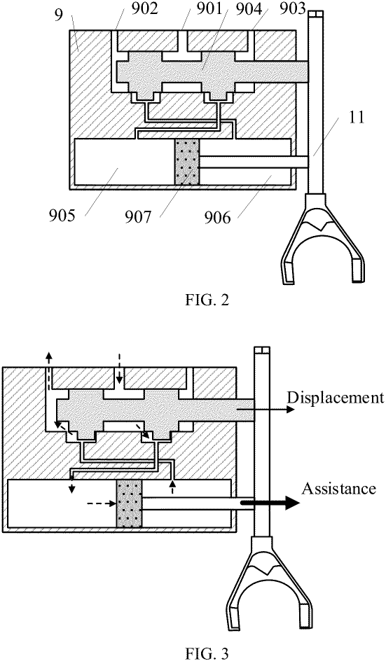

As shown in FIG. 2, the valve body 904 and the shift booster piston 907 are installed inside the shift booster mechanism 9 to provide torque for the shift execution module and assist the shift. Specifically, the shift booster mechanism 9 is equipped with the first cavity and the second cavity. The first cavity is used to set the valve body 904, and the second cavity is used to set the shift assist piston 907. The first cavity and the second cavity are cylindrical. There are three channels at the upper end of the first cavity and two channels at the lower end of the first cavity. The two channels at the lower end of the first cavity are connected with the shift assist left cylinder 905 and the shift assist right cylinder 906 of the second cavity, respectively. The upper end of the valve body 904 has a first-level step, and the lower end has two-level steps, which are matched with the structure of the first cavity. After assembling the valve body 904 and the shift booster piston 907, the shift booster mechanism 9 is separated into different regions, namely high-pressure oil circuit 901, left low-pressure circuit 902, right low-pressure circuit 903, shift assist left cylinder 905 and shift assist right cylinder 906. Valve body 904 and shift booster piston 907 are connected with the shift fork 11 in the shift execution sub-module in particular.

As shown in FIGS. 3 and 4, one end of the high-pressure oil circuit 901 is in communication with the high-pressure accumulator 7 through the hydraulic pipeline, and the other end is controlled by the valve body 904, which is often closed. When the valve body 904 moves to right, the high-pressure oil circuit 901 is in communication with the shift booster left cylinder 905. When the valve body 904 moves to left, the high-pressure oil circuit 901 is in communication with the shift booster right cylinder 906. One end of the left low-pressure circuit 902 is in communication with the oil storage cylinder 5 through the hydraulic pipeline, which is controlled by the valve body 904. When the valve body 904 remains in the middle position, the left low-pressure circuit 902 is often closed. When the valve body 904 moves to right, the left low-pressure circuit 902 is in communication with the shift booster right cylinder 906. When the valve body 904 moves to left, the left low-pressure is often closed. One end of the right low-pressure circuit 903 is in communication with the oil storage cylinder 5 through the hydraulic pipeline, which is controlled by the valve body 904. When the valve body 904 remains in the middle position, the right low-pressure circuit 903 is often closed. When the valve body 904 moves to right, the right low-pressure is often closed. When the valve body 904 moves to left, the right low-pressure circuit 903 is in communication with the shift booster left cylinder 905.

The shift booster mechanism 9 is assisted by the following process.

When the shift actuator sub-module does not shift, the valve body 904 is in a balanced position, and the left low-pressure circuit 902, high pressure oil circuit 901 and the right low-pressure circuit 903 are closed. The oil pressure of the shift booster left cylinder 905 and the shift booster right cylinder 906 is equal, and the shift booster piston 907 is not forced and does not assist. When the shift actuator sub-module shifts to right, the valve body 904 shifts to right. The shift booster left cylinder 905 is in communication with the high-pressure accumulator 7 with the high-pressure oil circuit 901, and the shift booster right cylinder 906 is in communication with the left low-pressure circuit 902 to the oil storage cylinder 5. The oil pressure of the shift booster left cylinder 905 is greater than that of the shift booster right cylinder 906. The left force is imposed on the shift booster piston 907, and then the shift booster piston 907 assists the fork in the shift actuator sub-module. When the shift actuator sub-module shifts to left, the valve body 904 moves to left. The shift booster right cylinder 906 is in communication with the high-pressure accumulator 7 with the high-pressure oil circuit 901, and the shift booster left cylinder 905 is in communication with the right low-pressure circuit 903 to the oil storage cylinder 5. The oil pressure of the shift booster left cylinder 905 is less than that of the shift booster right cylinder 906. The left force is imposed on the shift booster piston 907, and then the shift booster piston 907 assists the fork in the shift actuator sub-module.

As shown in FIG. 1, the shift actuator sub-module is composed of shift motor 13, shift guide rail 10 and shift fork 11, which is used to control the position of shift fork 11 and realize shift. In this implementation, shift motor 13 uses axial flux motor.

Shift motor 13 is connected with power distribution module. In particular, it is connected with the gear ring 12 in the power distribution module to transfer torque to the power distribution module. Shift guide rail 10 is connected with shift fork 11, and shift guide rail 10 is also connected with power distribution module. In particular, it is connected with the gear ring 12 in the power distribution module by means of a gear.

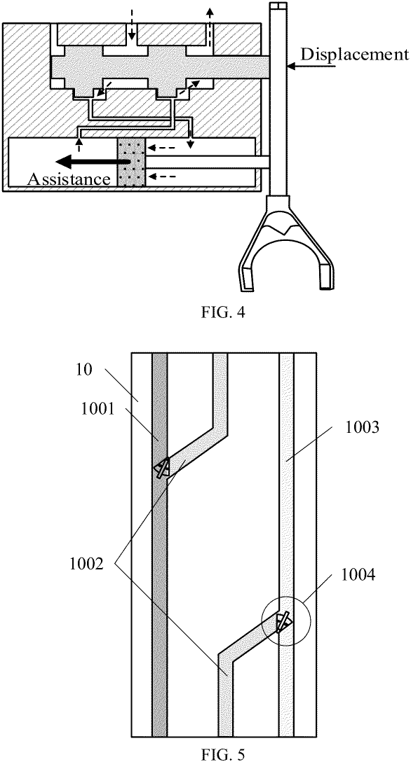

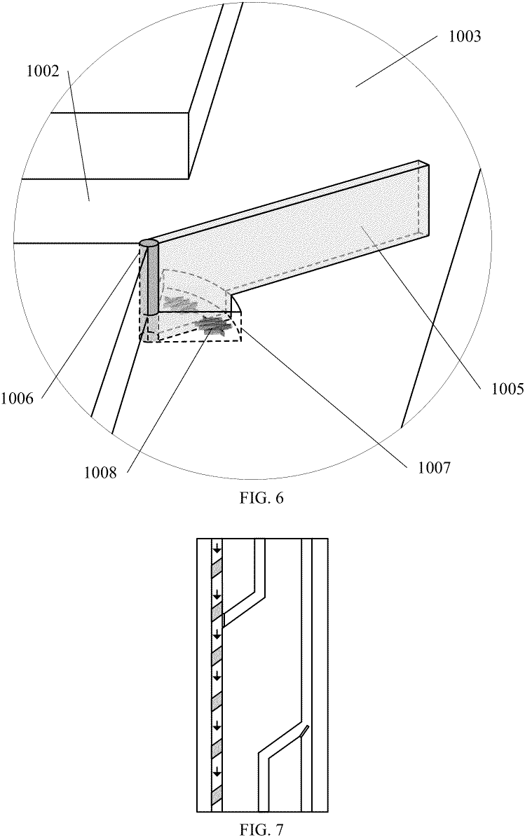

Shift guide rail 10 has a rail groove and shift guide mechanism 1004, used to control the position of shift fork 11. As shown in FIG. 5, specifically, there are rail grooves on the surface of shift guide rail 10, which are high gear rail groove 1001, shift rail groove 1002 and low gear rail groove 1003. High gear rail groove 1001 is annular straight groove, the shift rail groove 1002 is composed of two inclined grooves and one straight groove. The two inclined grooves are connected to the high gear rail groove 1001 and the low gear rail groove 1003 respectively. Low gear rail groove 1003 is annular straight groove, the intersection of high gear rail groove 1001 and shift rail groove 1002, and the intersection of low gear rail groove 1003 and shift rail groove 1002 are installed with shift guide mechanism 1004. As shown in FIG. 6, the shift guide mechanism 1004 comprises a baffle 1005, a hinge 1006, a sector groove 1007 and a reset spring 1008. Taking the shift guide mechanism 1004 at the intersection of a low gear rail groove 1003 and a shift rail groove 1002 as an example, the baffle 1005 is a long ladder, as shown in the axial measurement diagram in FIG. 6. The upper end is connected to the shift guide rail 10 through a hinge 1006, and the lower end locates in the middle of the rail groove by the constraint of the reset spring 1008. Specifically, the lower part of the baffle 1005 near the hinge 1006 is installed in the sector groove 1007 and connected with the reset spring 1008. The hinge 1006 is located at the intersection of the rail groove to connect the baffle 1005 and the shift guide rail 10, and the baffle 1005 is allowed to rotate with hinge 1006 as the axis. The sector groove 1007 is located at the intersection of the rail groove. Based on the surface of the rail groove, the groove is vertically downward, and the reset spring 1008 is installed in the sector groove 1007. One end of the reset spring 1008 is connected to the lower part of the baffle 1005 near the hinge 1006 end, and the other end is connected to the wall on both sides of the sector groove 1007.

The shift fork 11 is placed in the rail groove of the shift guide rail 10, which can move in the rail groove of the shift guide rail 10, and then realize the shift. In example 1, one end of the shift fork 11 is connected with the shift guide rail 10, and the other end is installed in the gearbox.

The shift actuator is assisted by the following process.

As shown in FIG. 7, the high gear maintenance process is as follows. When the shift fork 11 locates in the high gear rail groove 1001, the shift motor 13 rotates forward, and the motor torque passes through the gear ring 12 in the power distribution module to the shift guide rail 10. The shift guide rail 10 rotates in reverse, and the shift fork 11 moves in the high gear rail groove 1001. Further, when the shift fork 11 moves to the intersection of the high gear rail groove 1001 and the shift rail groove 1002, the shift fork 11 moves the baffle 1005 in the shift guide mechanism 1004 at the intersection of the high gear rail groove 1001 and the shift rail groove 1002. As a result, the shift rail groove 1002 is closed by the baffle 1005, and the shift fork 11 is still in the high gear rail groove 1001. At the end of the contact between the shift fork 11 and the baffle 1005, the baffle 1005 is returned to the initial position by the reset spring 1008, and the shift fork 11 keeps the gear position unchanged.

As shown in FIG. 9, the low gear maintenance process is as follows. When the shift fork 11 locates in the low gear rail groove 1003, the shift motor 13 is reversed, and the motor torque is transferred to the shift guide rail 10 through the gear ring 12 in the power distribution module. The shift guide rail 10 rotates positively, and the shift fork 11 moves in the low gear rail groove 1003. Further, when the shift fork 11 moves to the intersection of the low gear rail groove 1003 and the shift rail groove 1002, the shift fork 11 moves the baffle 1005 in the shift guiding mechanism 1004 at the intersection of the low gear rail groove 1003 and the shift rail groove 1002. As a result, the shift rail groove 1002 is closed by the baffle 1005, and the shift fork 11 is still in the low gear rail groove 1003. At the end of the contact between the shift fork 11 and the baffle 1005, the baffle 1005 is returned to the initial position by the reset spring 1008, and the shift fork 11 keeps the gear position unchanged.

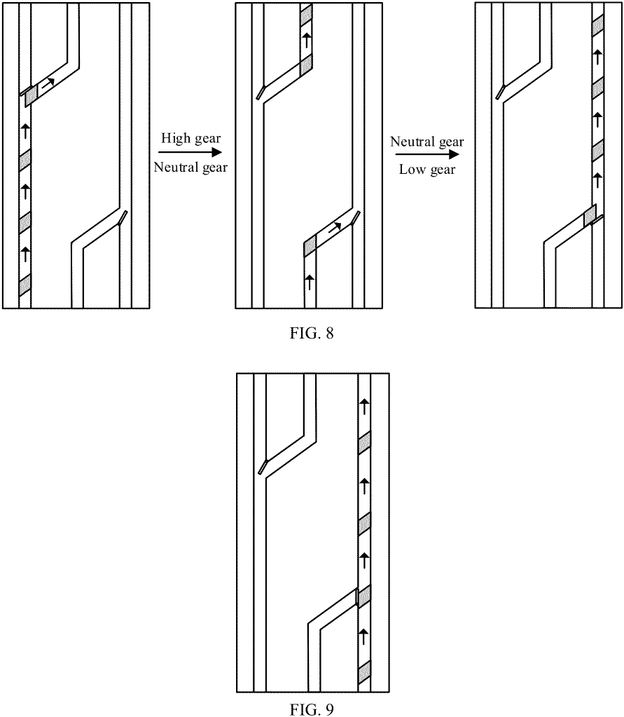

As shown in FIG. 8, the downshift process is as follows. Firstly, the shift fork 11 is located in the high gear rail groove 1001, and the shift motor 13 is reversed. The motor torque is transferred to the shift guide rail 10 through the gear ring 12 in the power distribution module. The shift guide rail 10 rotates positively, and the shift fork 11 moves in the high gear rail groove 1001. Further, when the shift fork 11 moves to the intersection of the high gear rail groove 1001 and the shift rail groove 1002, the shift fork 11 clockwise moves the baffle 1005 in the shift guide mechanism 1004 at the intersection of the high gear rail groove 1001 and the shift rail groove 1002. As a result, the baffle 1005 closes the high gear rail groove 1001, and then the shift fork 11 enters the shift rail groove 1002 along the baffle 1005. After the shift fork 11 enters the shift rail groove 1002, the baffle 1005 is returned to the initial position by the reset spring 1008, and the shift fork 11 is ready for a high-grade pickup, secondly, when the shift fork 11 enters the shift rail groove 1002 from the high gear rail groove 1001, the shift guide rail 10 rotates positively, and the shift fork 11 enters the inclined groove in the shift rail groove 1002, and the rotating shift guide rail 10 makes the shift fork 11 move horizontally to reset the gear to neutral. Shift rail 10 continues to rotate to make shift fork 11 in the shift rail groove 1002 straight groove. After waiting for the synchronization, shift rail 10 continues to rotate to make shift fork 11 enter another chute of shift rail groove 1002 horizontally to complete the gearing. Finally, the shift fork 11 clockwise forks the baffle 1005 in the shift guide rail 1004 in the intersection of the low gear rail groove 1003 and the shift rail groove 1002 to enter the low gear rail groove 1003. After the shift fork 11 enters the low gear rail groove 1003, the baffle 1005 returns to the initial position by the reset spring 1008.

The downshift process is as follows. Firstly, the shift fork 11 locates in the low gear rail groove 1003, and the shift motor 13 rotates forward. The motor torque is transferred through the gear ring 12 in the power distribution module to the shift guide rail 10. The shift guide rail 10 rotates backward, and the shift fork 11 moves in the low gear rail groove 1003. Further, when the shift fork 11 moves to the intersection of the low gear rail groove 1003 and the shift rail groove 1002, the shift fork 11 clockwise forks the battle 1005 in the intersection of the low gear rail groove 1003 and the shift rail groove 1002. As a result, the baffle 1005 closes the low gear rail groove 1003, and then the shift fork 11 enters the shift rail groove 1002 along the baffle 1005. After the shift fork 11 enters the shift rail groove 1002, the baffle 1005 returns to the initial position by the reset spring 1008, and the shift fork 11 is ready for a low gear pickup. Secondly, when the shift fork 11 enters the shift rail groove 1002 from the low gear rail groove 1003, the shift guide rail 10 rotates in reverse, and the shift fork 11 enters the inclined groove in the shift rail groove 1002, and the rotating shift guide rail 10 makes the shift fork 11 move horizontally to reset the gear to neutral. Shift guide rail 10 continues to rotate, shift fork 11 into the shift rail groove 1002 straight groove, shift fork 11 position does not change, the shift process synchronization waiting. The shift guide rail 10 further rotates, the shift fork 11 enters another chute of the shift rail groove 1002, and the shift fork 11 moves horizontally to complete the hanging gear. Finally, the baffle 1005 in the shift guide mechanism 1004 of shift fork 11 clockwise forks the intersection of low gear rail groove 1003 and shift rail groove 1002 to enter the high gear rail groove 1001. After the shift fork 11 enters the high gear rail groove 1001, the baffle 1005 is returned to the initial position by the reset spring 1008, and the shift fork 11 is upgraded from low gear to high gear.

As shown in FIG. 1, the brake-by-wire module comprises brake motor 18, screw 20, nut 19, brake piston 21, brake master cylinder 22, solenoid valve group 23, which is used for braking. In this implementation, the brake motor 18 adopts axial flux motor.

The end of the brake motor 18 is connected with the screw 20, and the other end is connected with the power distribution module. In particular, it is connected with the solar wheel 17 in the power distribution module to transfer torque to the power distribution module. One end of the screw 20 is connected to the brake motor 18, and the other end is connected to the nut 19. The nut 19 moves horizontally through the rotation of the screw 20. One end of nut 19 is connected to the screw 20, and the other end is connected to the brake piston 21. The brake piston 21 is pushed through the horizontal movement of nut 19. One end of brake piston 21 is connected with nut 19, and the other end is connected with brake master cylinder 22. The oil pressure in brake master cylinder 22 is changed by the driving force of brake piston 21. The end of the brake master cylinder 22 is connected to the brake piston 21 and the other end is connected to the solenoid valve group 23 to convert the driving force of the brake piston 21 into the hydraulic pressure of the oil circuit. Specifically, spring is installed in brake master cylinder 22 to reset brake piston 21. The solenoid valve group 23 is used to adjust the hydraulic pressure of the oil pipeline for the distribution and adjustment of braking force. As shown in FIG. 1, the solenoid valve group 23 is composed of a booster solenoid valve, a pressure relief solenoid valve and a brake wheel cylinder. The booster solenoid valve is connected to the brake wheel cylinder through the input port of the oil pressure pipeline, and the pressure relief solenoid valve is connected to the pressure relief solenoid valve through the output port of the oil pressure pipeline. The pressure relief solenoid valve is connected to the booster solenoid valve through the output port of the oil pressure pipeline, and the brake master cylinder 22 through the output port of the oil pressure pipeline.

The braking process of the brake-by-wire module is as follows. When the brake-by-wire module is used for braking pressurization, the supercharged solenoid valve of the solenoid valve group 23 is opened, and the depressurized solenoid valve is closed. The brake motor is 18 positive rotation, and the torque is converted to the horizontal force to the right by the screw 20 and nut 19, which drives the brake piston 21, so that the oil enters the brake wheel cylinder through the supercharged solenoid valve from the brake master cylinder 22 to generate braking force and realize the braking pressurization. When the brake-by-wire module is used for brake decompression, the booster solenoid valve of the solenoid valve group 23 is opened, the unloading solenoid valve is opened, the brake motor 18 is reversed, and the torque is transformed into the left horizontal force to pull the brake piston 21 through the screw 20 and nut 19, so that the oil is returned from the brake wheel cylinder through the unloading solenoid valve to the brake master cylinder 22, reducing the braking force and realizing the brake decompression.

The power distribution module comprises gear ring 12, planetary frame 14, solar wheel 17, the first brake 15 and the second brake 16, which is used to distribute the motor torque in the redundant process and realize a variety of working conditions. At the same time, when the shift actuator sub-module and the brake-by-wire sub-module work normally, they do not interfere with each other.

Planet gear is set on planetary frame 14, through which planetary frame 14 is connected with gear ring 12 and solar wheel 17. Planetary frame 14 is connected with gear ring 12 through the second brake 16, and planetary frame 14 is connected with gearbox housing through the first brake 15. The side of the gear ring 12 is connected to the planetary frame of the planetary carrier 14, and the other side of the gear ring is connected to the shift motor 13 of the shift execution submodule. The side of the solar 17 wheel is connected with the planetary wheel of the planetary carrier 14, and the other end is connected with the brake motor 18 of the line control drive module. The first brake 15 connects the gearbox shell and the planetary carrier 14. When the first brake 15 is locked, the position of the planetary carrier 14 is fixed, the power distribution module is proportionally driven, and the gear ring 12 is opposite to the rotation direction of the solar wheel 17. The second brake 16 connects planetary carrier 14 and gear ring 12. When the second brake 16 is locked, the relative position of planetary carrier 14 and gear ring 12 is fixed. The power distribution module is directly geared, and gear ring 12 has the same rotation direction with solar wheel 17.

The power distribution process of power distribution module is as follows.

When the first brake 15 releases and the second brake 16 releases, the power distribution module is unconstrained. The gear ring 12 and the solar wheel 17 rotate independently, and do not interfere with each other. If there is no motor failure, the brake-by-wire module and shift module work independently. If the shift motor 13 is faulty, only brake-by-wire module can work. If the brake motor 18 is faulty, only shift module can work.

When the first brake 15 locks and the second brake 16 releases, the position of planetary carrier 14 is fixed, and the power is proportionally transferred. The rotation direction of gear ring 12 is opposite to that of solar wheel 17 with solar wheel 17 rotates forward, and the torque is transferred to gear ring 12 through planetary carrier 14, and gear ring 12 rotates reversely. Similarly, the gear ring 12 rotates forward, and the torque is transferred to the solar wheel 17 through the planetary carrier 14. The solar wheel 17 rotates backward. At this time, if the shift motor 13 is faulty, the torque of the brake motor 18 is forward transferred to the shift guide rail 10 in the shift module through the power distribution module. If the brake motor 18 is faulty, the torque of shift motor 13 is inversely transferred to the screw 20 in the brake-by-wire module through the power distribution module.

When the first brake 15 releases and the second brake 16 locks, the planetary carrier 14 and the gear ring 12 are relatively fixed, and the power is directly transferred. The gear ring 12 and the solar wheel 17 rotate in the same direction with the solar wheel 17 rotates forward, and the torque is transferred to the gear ring 12 and the gear ring 12 rotates forward through the planetary carrier 14. Similarly, the gear ring 12 rotates forward, and the torque is transferred to the solar wheel 17 through planetary gear 14, and the solar wheel 17 rotates forward, at this time, if the shift motor 13 is faulty, the torque of the brake motor 18 is inversely transferred to the shift guide rail 10 in the shift module through the power distribution module, if the brake motor 18 is faulty, the torque of shift motor 13 is transferred to the screw 20 in the brake-by-wire module through the power distribution module.

The control assembly module is composed of brake pedal angle sensor 24, shift motor controller 25, brake motor controller 26 and electronic control unit 27 to switch among different modes, so as to meet the needs of system working conditions and the safety and stability of the system.

The electronic control unit 27 receives the signal of the brake pedal angle sensor 24 and the oil pressure information of the shift booster sub-module collected by the oil pressure gauge 8. The electronic control unit 27 judges shift demand according to vehicle speed information, and records gear position to obtain shift signal. The electronic control unit 27 receives the fault information and current signal of the shift motor controller 25 and the brake motor controller 26 to control the shift motor 13 and the brake motor 18, and controls the lock or release of the first brake 15 and the second brake 16, as well as the on and off of the solenoid valve group 23.

The electronic control unit 27 obtains the system control code mode by judging shift signal and braking signal. The code explanation is shown in table 1.

TABLE 1

Code table for system control
Description of the system status and control codes

| | | |
|---|---|---|
| Shift status | Upshift | (2, _, _) |
| | Downshift | (1, _, _) |
| | No shifting | (0, _, _) |
| Brake status | Brake pressurization | (_, 2, _) |
| | Brake depressurization | (_, 1, _) |
| | No braking | (_, 0, _) |
| Gear status | No influence | (_, _, 2) |
| | In high gear | (_, _, 1) |
| | In low gear | (_, _, 0) |

Shift motor controller 25 receives the control signal issued by the electronic control unit 27, and it controls shift motor 13 to perform corresponding commands, and feedbacks the fault signal and current signal of shift motor 13 to the electronic control unit 27 to form control. The brake motor controller 26 receives the control signal issued by the electronic control unit 27, controls the brake motor 18 to execute the corresponding commands, and feedbacks the fault signal and current signal of brake motor 18 to the electronic control unit 27 to form control.

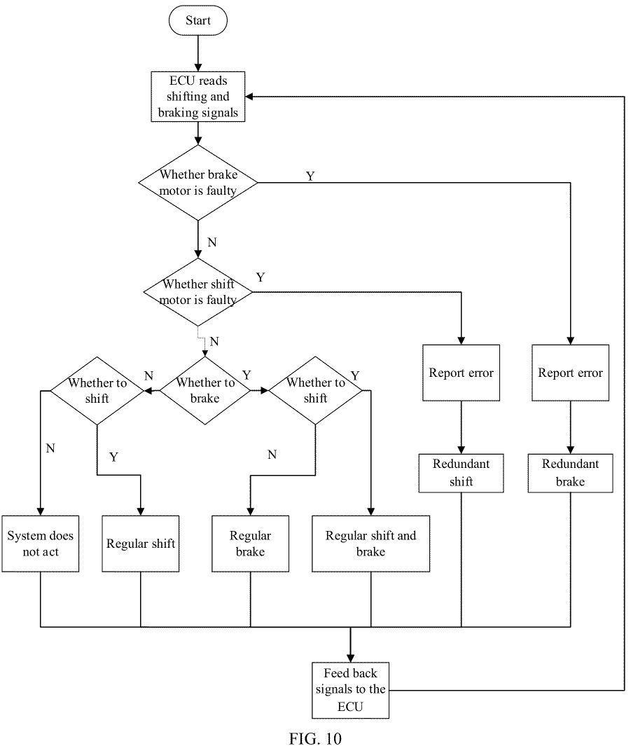

The FIG. 10 shows the control process of a mechanical-hydraulic compound dual motor brake-shift integrated system. The specific control methods are as follows:

51, feeding back the operating status signals of the shift motor 13 and the brake motor 18 to the electronic control unit 27 and then starting S2.

S2, detecting whether the brake motor 18 is faulty. If the brake motor 18 is not faulty, the system starts S3. If the brake motor 18 is faulty, the system reports error with the shift motor 13 performing a redundant brake, and then the system starts S7.

S3, detecting whether the shift motor 13 is faulty. If the shift motor 13 is not faulty, the system starts S4. If the shift motor 13 is faulty, the system reports error with the brake motor 18 performing a redundant shift, and then the system starts S8.

S4, detecting whether to perform a brake. If the brake will be performed, the system starts S5. If the brake will not be performed, the system starts S6.

S5, detecting whether to perform a shift. If the shift will be performed, the shift motor 13 performs a regular shift and the brake motor 18 performs a regular shift, and then the system starts S9. If the shift will not be performed, the brake motor 18 performs a regular brake and then the system starts S9.

The regular shift mode is specifically as follows. Without motor fault, the electronic control unit 27 controls the shift motor 13. The first brake 15 is released, and the second brake 16 is released. The shift actuator sub-module and the brake-by-wire module work independently, and the positive and negative rotations of shift motor 13 are controlled to realize the switch between high and low gears.

The conventional braking mode is specifically as follows. Without motor fault, the electronic control unit 27 controls the brake motor 18. The first brake 15 is released, and the second brake 16 is released. The shift actuator sub-module and the brake-by-wire module work independently, and the positive and reverse of the brake motor 18 and the on and off of the solenoid valve group 23 are controlled to realize the switching of braking pressurization and depressurization.

S6, detecting whether to perform a shift. If the shift will be performed, the shift motor 13 performs a regular shift and then the system starts S9. If the shift will not be performed, the system does not act and then starts S9.

S7, starting the redundant brake mode. Through the first brake 15 and the second brake 16 in the power distribution module, the shift motor 13 meets the functions of shifting and braking at the same time and then the system starts S9.

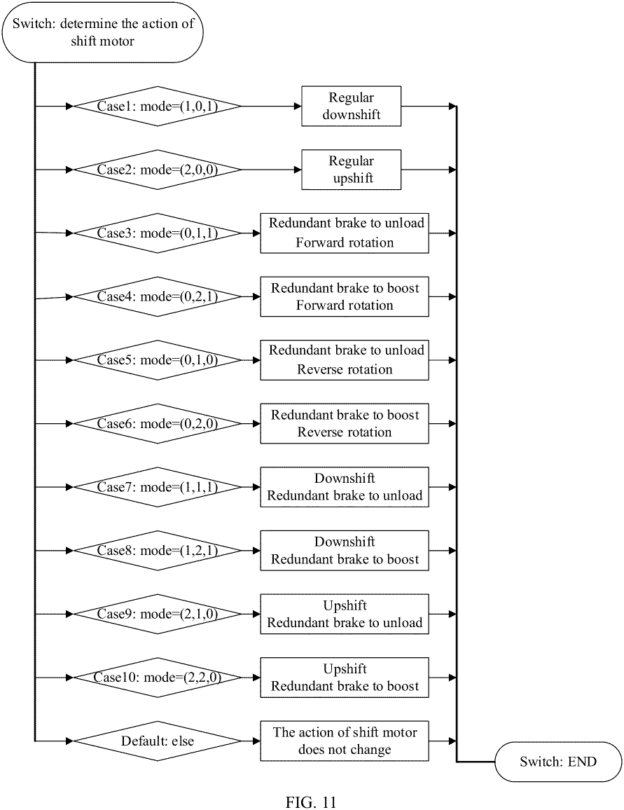

Referring to the description of system state and control code in Table 1, as well as the flow chart of redundant brake mode in FIG. 11, the redundant brake mode described in Step 7 can be divided into the following working states.

According to the system control code mode, it enters the corresponding state.

The first state is that if the mode= (1,0,1) it means that the downshift is required, and there is no brake. The gear position is in the high gear, and the shift motor 13 rotates backward. Specifically, the brake motor 18 is faulty, and the electronic control unit 27 controls shift motor 13 to rotated backward. The first brake 15 and the second brake 16 release, while shift actuator module independently work to downshift.

The second state is that if mode= (2,0,0) it means that the upshift is required, and there is no brake. The gear position is in the high gear, and the shift motor 13 rotates forward. Specifically, the brake motor 18 is faulty, and the electronic control unit 27 controls shift motor 13 to rotate forward. The first brake 15 and the second brake 16 release, while shift actuator module independently work to upshift.

The third state is that if mode= (0,1,1) it is determined that there is no shift, and brake depressurization is carried out. The gear position is in the high gear, and the shift motor 13 rotates forward. At the same time, brake depressurization is carried out. Specifically, brake motor 18 is faulty, and the electronic control unit 27 controls shift motor 13 to rotate forward. At the same time, the first brake 15 releases and the second brake 16 locks. The torque of shift motor 13 is transferred to the screw 20 in the brake-by-wire module through the power distribution module, and the brake piston 21 is pulled through the screw 20, nut 19. The booster solenoid valve in the solenoid valve group 23 is opened and the pressure relief solenoid valve is opened. The oil returns to the brake master cylinder 22 through the pressure relief solenoid valve from the brake wheel cylinder, and reduces the braking force to meet the working condition of the shift motor 13 redundant braking of shift motor 13 redundant braking to unload.

The fourth state is that if mode= (0,2,1) it is determined that there is no shift, and brake pressurization is carried out. The gear position is in a high gear, and the shift motor 13 rotates forward. At the same time, brake pressurization is carried out. Specifically, brake motor 18 is faulty, and the electronic control unit 27 controls shift motor 13 to rotate forward. At the same time, the first brake 15 releases and the second brake 16 locks, and the torque of the shift motor 13 is forward transferred to the screw 20 in the brake-by-wire module through the power distribution module, and the brake piston 21 is pushed by the screw 20, nut 19. In the solenoid valve group 23, the booster solenoid valve is opened and the pressure relief solenoid valve is closed. The oil enters the brake wheel cylinder from the brake master cylinder 22 through the booster solenoid valve to generate the braking force to meet the working condition of the shift motor 13 redundant braking to boost.

The fifth state is that if mode= (0,1,0) it is determined that there is no shift, and brake depressurization is carried out. The gear position is in a low gear, and the shift motor 13 rotates backward. At the same time, brake depressurization is carried out. Specifically, brake motor 18 is faulty, and the electronic control unit 27 controls shift motor 13 to rotate backward. At the same time, the first brake 15 releases and the second brake 16 locks, and the torque of the shift motor 13 is transferred to the screw 20 in the brake-by-wire module through the power distribution module, and the brake piston 21 is pushed by the screw 20, nut 19. In the solenoid valve group 23, the booster solenoid valve is opened and the pressure relief solenoid valve is opened. The oil returns to the brake master cylinder 22 through the pressure relief solenoid valve from the brake wheel cylinder, and reduces the braking force to meet the working condition of the shift motor 13 redundant braking of shift motor 13 redundant braking to unload.

The sixth state is that if mode= (0,2,0) it is determined that there is no shift, and brake pressurization is carried out. The gear position is in a low gear, and the shift motor 13 rotates backward. At the same time, brake pressurization is carried out. Specifically, brake motor 18 is faulty, and the electronic control unit 27 controls shift motor 13 to rotate backward. At the same time, the first brake 15 locks and the second brake 16 releases, and the torque of the shift motor 13 is backward transferred to the screw 20 in the brake-by-wire module through the power distribution module, and the brake piston 21 is pushed by the screw 20, nut 19. In the solenoid valve group 23, the booster solenoid valve is opened and the pressure relief solenoid valve is closed. The oil enters the brake wheel cylinder from the brake master cylinder 22 through the booster solenoid valve to generate the braking force to meet the working condition of the shift motor 13 redundant braking to boost.

The seventh state is that if mode= (1,1,1) it means that the downshift is required, and brake depressurization is carried out. The gear position is in the high gear, and the shift motor 13 rotates forward, while the redundant braking is carried out to unload. Specifically, brake motor 18 is faulty, and the electronic control unit 27 controls shift motor 13 to rotate backward. Shift fork 11 moves from high gear rail groove 1001 to the low gear rail groove 1003 to complete downshift. At the same time, the first brake 15 releases and the second brake 16 locks, and the torque of the shift motor 13 is forward transferred to the screw 20 in the brake-by-wire module through the power distribution module to push the brake piston 21 by the screw 20 and nut 19. In the solenoid valve group 23, the booster solenoid valve is opened and the pressure relief solenoid valve is opened. The oil returns to the brake master cylinder 22 through the pressure relief solenoid valve from the brake wheel cylinder, and reduces the braking force to meet the working condition of the shift motor 13 shifting to low gear and redundant braking to unload.

The eighth state is that if mode= (1,2,1) it means that the downshift is required, and brake pressurization is carried out. The gear position is in the high gear, and the shift motor 13 rotates backward, while the redundant braking is carried out to boost. Specifically, brake motor 18 is faulty, and the electronic control unit 27 controls shift motor 13 to rotate backward. Shift fork 11 moves from high gear rail groove 1001 to the low gear rail groove 1003 to complete downshift. At the same time, the first brake 15 locks and the second brake 16 releases, and the torque of the shift motor 13 is backward transferred to the screw 20 in the brake-by-wire module through the power distribution module to push the brake piston 21 by the screw 20, nut 19. In the solenoid valve group 23, the booster solenoid valve is opened and the pressure relief solenoid valve is closed. The oil enters the brake wheel cylinder from the brake master cylinder 22 through the booster solenoid valve to generate the braking force to meet the working condition of the shift motor 13 shifting to low gear and redundant braking to boost.

The ninth state is that if mode= (2,1,0) it means that the upshift is required, and brake depressurization is carried out. The gear position is in the low gear, and the shift motor 13 rotates forward, while the redundant braking is carried out to unload. Specifically, brake motor 18 is faulty, and the electronic control unit 27 controls shift motor 13 to rotate forward. Shift fork 11 moves from low gear rail groove 1003 to the high gear rail groove 1001 to complete upshift. At the same time, the first brake 15 locks and the second brake 16 releases, and the torque of the shift motor 13 is backward transferred to the screw 20 in the brake-by-wire module through the power distribution module to push the brake piston 21 by the screw 20, nut 19. In the solenoid valve group 23, the booster solenoid valve is opened and the pressure relief solenoid valve is opened. The oil returns to the brake master cylinder 22 through the pressure relief solenoid valve from the brake wheel cylinder, and reduces the braking force to meet the working condition of the shift motor 13 shifting to high gear and redundant braking to unload.

The tenth state is that if mode= (2,2,0) it means that the upshift is required, and brake pressurization is carried out. The gear position is in the low gear, and the shift motor 13 rotates forward, while the redundant braking is carried out to boost. Specifically, brake motor 18 is faulty, and the electronic control unit 27 controls shift motor 13 to rotate forward. Shift fork 11 moves from low gear rail groove 1003 to the high gear rail groove 1001 to complete upshift. At the same time, the first brake 15 releases and the second brake 16 locks, and the torque of the shift motor 13 is forward transferred to the screw 20 in the brake-by-wire module through the power distribution module to push brake piston 21 by the screw 20, nut 19. In the solenoid valve group 23, the booster solenoid valve is opened and the pressure relief solenoid valve is closed. The oil enters the brake wheel cylinder from the brake master cylinder 22 through the booster solenoid valve to generate the braking force to meet the working condition of the shift motor 13 shifting to high gear and redundant braking to boost.

The eleventh state is that other mode values at this time are meaningless, it is determined that there is no shift and brake, and then feedback shift motor 13 working state signal to the electronic control unit 27.

S8, starting the redundant shift mode. Through the first brake 15 and the second brake 16 in the power distribution module, the brake motor 18 meets the functions of shifting and braking at the same time and then the system starts S9.

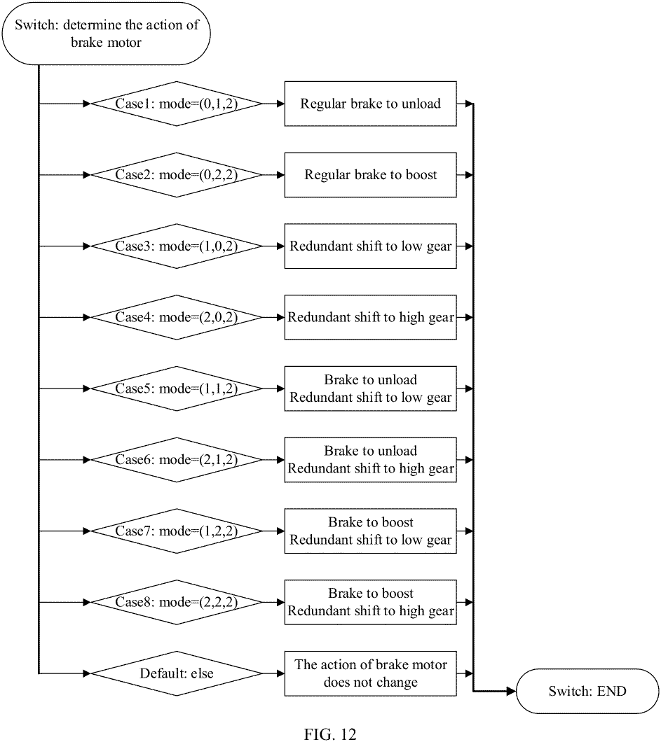

Refer to FIG. 12, the redundant shift mode can be divided into the following cases.

The first state is that if mode= (0,1,2) it is determined that there is no shift, and brake depressurization is carried out. The gear has no effect on system control and brake motor 18 performs a regular brake to unload. Specifically, shift motor 13 is faulty. The first brake 15 releases and the second brake 16 releases, brake-by-wire module independently work to control brake motor 18 to rotate backward. In the solenoid valve group 23, the booster solenoid valve is opened and the pressure relief solenoid valve is opened to meet the working condition of the brake motor 18 braking to unload.

The second state is that if mode= (0,2,2) it is determined that there is no shift, and brake pressurization is carried out. The gear has no effect on system control and brake motor 18 performs a regular brake to boost. Specifically, shift motor 13 is faulty. The first brake 15 releases and the second brake 16 releases, brake-by-wire module independently work to control brake motor 18 to rotate forward. In the solenoid valve group 23, the booster solenoid valve is opened and the pressure relief solenoid valve is closed to meet the working condition of the brake motor 18 braking to boost.

The third state is that if mode= (1,0,2) it means that the downshift is required, and there is no brake. The gear has no effect on system control and brake motor 18 performs a redundant shift to low gear. Specifically, shift motor 13 is faulty, and the electronic control unit 27 controls brake motor 18 to rotate forward. In the solenoid valve group 23, the booster solenoid valve is closed and the pressure relief solenoid valve is opened. The oil returns to the brake master cylinder 22 through the pressure relief solenoid valve from the brake master cylinder 22 without entering the brake cylinder to generate braking force. The first brake 15 is locked and the second brake 16 is released. The torque of the brake motor 18 is forward transferred to the shift guide rail 10 in the shift module through the power distribution module. The rotation of the shift track will be transformed into the horizontal movement of the shift fork 11 to meet the working condition of the brake motor 18 redundant shifting to low gear.

The fourth state is that if mode= (2,0,2) it means that the upshift is required, and there is no brake. The gear has no effect on system control and brake motor 18 performs a redundant shift to high gear. Specifically, shift motor 13 is faulty, and the electronic control unit 27 controls brake motor 18 to rotate forward. In the solenoid valve group 23, the booster solenoid valve is closed and the pressure relief solenoid valve is opened. The oil returns to the brake master cylinder 22 through the pressure relief solenoid valve from the brake master cylinder 22 without entering the brake cylinder to generate braking force. The first brake 15 is released and the second brake 16 is locked. The torque of the brake motor 18 is backward transferred to the shift guide rail 10 in the shift module through the power distribution module. The rotation of the shift track will be transformed into the horizontal movement of the shift fork 11 to meet the working condition of the brake motor 18 redundant shifting to high gear.

The fifth state is that if mode= (1,1,2) it means that the downshift is required, and brake depressurization is carried out. The gear has no effect on system control and brake motor 18 performs a regular brake to unload and a redundant shift to low gear. Specifically, shift motor 13 is faulty, and the electronic control unit 27 controls brake motor 18 to rotate backward. In the solenoid valve group 23, the booster solenoid valve is opened and the pressure relief solenoid valve is opened. The oil returns to the brake master cylinder 22 through the pressure relief solenoid valve from the brake wheel cylinder to reduce the braking force. The first brake 15 is released and the second brake 16 is locked. The torque of the brake motor 18 is backward transferred to the shift guide rail 10 in the shift module through the power distribution module. The rotation of the shift track will be transformed into the horizontal movement of the shift fork 11 to meet the working condition of the brake motor 18 braking to unload and redundant shifting to low gear.

The sixth state is that if mode= (2,1,2) it means that the upshift is required, and brake depressurization is carried out. The gear has no effect on system control and brake motor 18 performs a regular brake to unload and a redundant shift to high gear. Specifically, shift motor 13 is faulty, and the electronic control unit 27 controls brake motor 18 to rotate backward. In the solenoid valve group 23, the booster solenoid valve is opened and the pressure relief solenoid valve is opened. The oil returns to the brake master cylinder 22 through the pressure relief solenoid valve from the brake wheel cylinder to reduce the braking force. The first brake 15 is locked and the second brake 16 is released. The torque of the brake motor 18 is forward transferred to the shift guide rail 10 in the shift module through the power distribution module. The rotation of the shift track will be transformed into the horizontal movement of the shift fork 11 to meet the working condition of the brake motor 18 braking to unload and redundant shifting to high gear.

The seventh state is that if mode= (1,2,2) it means that the downshift is required, and brake pressurization is carried out. The gear has no effect on system control and brake motor 18 performs a regular brake to boost and a redundant shift to low gear. Specifically, shift motor 13 is faulty, and the electronic control unit 27 controls brake motor 18 to rotate forward. In the solenoid valve group 23, the booster solenoid valve is opened and the pressure relief solenoid valve is closed. The oil enters the brake wheel cylinder from the brake master cylinder 22 through the booster solenoid valve to generate the braking force. The first brake 15 is locked and the second brake 16 is released. The torque of the brake motor 18 is forward transferred to the shift guide rail 10 in the shift module through the power distribution module. The rotation of the shift track will be transformed into the horizontal movement of the shift fork 11 to meet the working condition of the brake motor 18 braking to boost and redundant shifting to low gear.

The eighth state is that if mode= (2,2,2) it means that the upshift is required, and brake pressurization is carried out. The gear has no effect on system control and brake motor 18 performs a regular brake to boost and a redundant shift to high gear. Specifically, shift motor 13 is faulty, and the electronic control unit 27 controls brake motor 18 to rotate forward. In the solenoid valve group 23, the booster solenoid valve is opened and the pressure relief solenoid valve is closed. The oil enters the brake wheel cylinder from the brake master cylinder 22 through the booster solenoid valve to generate the braking force. The first brake 15 is released and the second brake 16 is locked. The torque of the brake motor 18 is backward transferred to the shift guide rail 10 in the shift module through the power distribution module. The rotation of the shift track will be transformed into the horizontal movement of the shift fork 11 to meet the working condition of the brake motor 18 braking to boost and redundant shifting to high gear.

The ninth state is that other mode values at this time are meaningless, it is determined that there is no shift and brake, and then feedback working state signal of brake motor 18 to the electronic control unit 27.

S9, feeding back the operating status signals of the shift motor 13 and the brake motor 18 to the electronic control unit 27 for control.

What is claimed is:

1. A brake-shift integrated system based on machine-hydraulic compound, comprising a shift module, a brake-by-wire module, a power distribution module, and a control assembly module, wherein
the shift module comprises a shift booster sub-module and a shift actuator sub-module; the shift booster sub-module comprises a brake pedal and a brake piston cylinder; the brake piston cylinder is connected to the brake pedal, and a tail end of the brake piston cylinder is in communication with two hydraulic lines, a first hydraulic line of the two hydraulic lines is in one-way communication with an oil storage cylinder, and a second hydraulic line of the two hydraulic lines is in one-way communication with a high-pressure accumulator; the high-pressure accumulator is connected to a shift booster mechanism through a hydraulic line, and the shift booster mechanism is connected to the oil storage cylinder through a hydraulic line; the shift booster mechanism is connected to the power distribution module; the shift actuator sub-module comprises a shift motor, a shift guide rail, and a shift fork; the shift guide rail is connected to the shift fork, and-the shift guide rail is connected to the power distribution module, and the power distribution module is fixedly connected to the shift motor;
the power distribution module is connected to a brake motor in the brake-by-wire module; and
the control assembly module comprises an electronic control unit, and the electronic control unit is in signal connection to a brake pedal angle sensor a shift motor controller, and a brake motor controller.

2. The brake-shift integrated system based on machine-hydraulic compound according to claim 1, wherein the shift booster mechanism is provided with a first cavity and a second cavity, wherein the first cavity and the second cavity are interconnected, the first cavity is provided with a valve body, and the second cavity is provided with a shift booster piston; the first cavity is provided with three channels at an upper end and two channels at a lower end; the three channels at the upper end form a high-pressure oil circuit and a low-pressure circuit at the left and right ends; the high-pressure oil circuit is in communication with the high-pressure accumulator, and the low-pressure circuit at the left and right ends is in communication with the oil storage cylinder; the two channels at the lower end are connected to the-two shift booster cylinders in the second cavity; the valve body and the shift booster piston are fixed to the shift fork.

3. The brake-shift integrated system based on machine-hydraulic compound according to claim 1, wherein a surface of the shift guide rail is provided with a high gear rail groove, a shift rail groove and a low gear rail groove, wherein the shift rail groove is connected to the high gear rail groove and the low gear rail groove by two sloping grooves at each end, and a connection is provided with a shift guide mechanism.

4. The brake-shift integrated system based on machine-hydraulic compound according to claim 3, wherein the shift guide mechanism comprises a baffle and a reset spring, while the baffle is connected to the shift guide rail and a bottom end is restrained by the reset spring.

5. The brake-shift integrated system based on machine-hydraulic compound according to claim 1, wherein the brake-by-wire module comprises a brake motor, a screw rod, a nut, a brake piston, a brake master cylinder and a solenoid valve group; the brake motor is fixed to one end of the screw rod, and an other end of the screw rod is connected to one end of the nut; an other end of the nut is connected to one end of the brake piston; an other end of the brake piston is connected to one end of the brake master cylinder; an other end of the brake master cylinder is connected to the solenoid valve group; the solenoid valve group comprises a booster solenoid valve, a pressure relief solenoid valve and a brake wheel cylinder.

6. The brake-shift integrated system based on machine-hydraulic compound according to claim 1, wherein the power distribution module comprises a gear ring, a planetary carrier, a sun wheel, a first brake and a second brake, wherein the planetary carrier is connected to a gearbox case via the first brake and to the gear ring via the second brake, which is connected to the shift motor; the planetary carrier is also connected to the solar wheel, which is connected to the brake motor.

7. A control method of the brake-shift integrated system based on machine-hydraulic compound according to claim 1, comprising the following steps:
S1, detecting whether the brake motor is faulty, wherein if the brake motor is not faulty, the brake-shift integrated system starts S2; if the brake motor is faulty, the brake-shift integrated system starts S6, and the shift motor will power braking;
S2, detecting whether the shift motor is faulty, wherein if the shift motor is not faulty, the brake-shift integrated system starts S3; if the shift motor is faulty, the brake-shift integrated system starts S7, and the brake motor will power shifting;
S3, detecting whether to perform a brake, wherein if the brake will be performed, the brake-shift integrated system starts S4; if the brake will not be performed, the brake-shift integrated system starts S5;
S4, detecting whether to perform a shift, wherein if the shift will be performed, the brake-shift integrated system performs a regular shift and a regular brake and then starts S8; if the shift will not be performed, the brake-shift integrated system performs a regular brake only and then starts S8;
S5, detecting whether to perform a shift, wherein if the shift will be performed, the brake-shift integrated system performs a regular shift and then starts S8; if the shift will not be performed, the brake-shift integrated system does not act and then starts S8;
S6, starting a redundant brake mode, wherein shift and brake functions are performed simultaneously by the shift motor and then the brake-shift integrated system starts S8;
S7, starting a redundant shift mode, wherein the shift and brake functions are performed simultaneously by the brake motor and then the brake-shift integrated system starts S8; and
S8, feeding back operating status signals of the shift motor and the brake motor to the electronic control unit for control.

8. The control method according to claim 7, wherein the redundant brake mode comprises the following operating states:
a first state is that the brake will not be performed with gear being in high, and the shift motor performs a regular downshift;
a second state is that the brake will not be performed with gear being in low, and the shift motor performs a regular upshift;
a third state is that the shift motor performs a redundant brake to release pressure by forward rotation with gear being in high;
a fourth state is that the shift motor performs the redundant brake to load pressure by forward rotation with gear being in high;
a fifth state is that the shift motor performs the redundant brake to release pressure by reverse rotation with gear being in low;
a sixth state is that the shift motor performs the redundant brake to load pressure by reverse rotation with gear being in low;
a seventh state is that the shift motor performs-a the redundant brake to release pressure by reverse rotation with gear being in high;
the-an eighth state is that the shift motor performs the redundant brake to load pressure by reverse rotation with gear being in high;
a ninth state is that the shift motor performs the redundant brake to release pressure by forward rotation with gear being in low; and
a tenth state is that the shift motor performs the redundant brake to load pressure by forward rotation with gear being in low.

9. The control method according to claim 7, wherein the redundant shift mode comprises the following cases:
a first case is that the brake motor performs a regular brake to release pressure, and the gear has no effect on system control;
a second case is that the brake motor performs the regular brake to load pressure, and the gear has no effect on system control;
a third case is that the brake motor performs a redundant shift to downshift, and the gear has no effect on system control;
a fourth case is that the brake motor performs the redundant shift to upshift, and the gear has no effect on system control;
a fifth case is that the brake motor performs the regular brake to release pressure and the redundant shift to downshift, and the gear has no effect on system control;
a sixth case is that the brake motor performs the regular brake to release pressure the redundant shift to upshift, and the gear has no effect on system control;
a seventh case is that the brake motor performs the regular brake to load pressure and the redundant shift to downshift, and the gear has no effect on system control; and
an eighth case is that the brake motor performs the regular brake to load pressure the redundant shift to upshift, and the gear has no effect on system control.

10. A wire-controlled vehicle, comprising the brake-shift integrated system based on machine-hydraulic compound according to claim 1.

11. The control method according to claim 7, wherein in the brake-shift integrated system based on machine-hydraulic compound, the shift booster mechanism is provided with a first cavity and a second cavity, wherein the first cavity and the second cavity are interconnected, the first cavity is provided with a valve body, and the second cavity is provided with a shift booster piston; the first cavity is provided with three channels at an upper end and two channels at a lower end; the three channels at the upper end form a high-pressure oil circuit and a low-pressure circuit at left and right ends; the high-pressure oil circuit is in communication with the high-pressure accumulator, and the low-pressure circuit at the left and right ends is in communication with the oil storage cylinder; the two channels at the lower end are connected to two shift booster cylinders in the second cavity; the valve body and the shift booster piston are fixed to the shift fork.

12. The control method according to claim 7, wherein in the brake-shift integrated system based on machine-hydraulic compound, a surface of the shift guide rail is provided with a high gear rail groove, a shift rail groove and a low gear rail groove, wherein the shift rail groove is connected to the high gear rail groove and the low gear rail groove by two sloping grooves at each end, and a connection is provided with a shift guide mechanism.

13. The control method according to claim 12, wherein in the brake-shift integrated system based on machine-hydraulic compound, the shift guide mechanism comprises a baffle and a reset spring, while the baffle is connected to the shift guide rail and a bottom end is restrained by the reset spring.

14. The control method according to claim 7, wherein in the brake-shift integrated system based on machine-hydraulic compound, the brake-by-wire module comprises a brake motor, a screw rod, a nut, a brake piston, a brake master cylinder and a solenoid valve group; the brake motor is fixed to one end of the screw rod, and an other end of the screw rod is connected to one end of the nut; an other end of the nut is connected to one end of the brake piston; an other end of the brake piston is connected to one end of the brake master cylinder; an other end of the brake master cylinder is connected to the solenoid valve group; the solenoid valve group comprises a booster solenoid valve, a pressure relief solenoid valve and a brake wheel cylinder.

15. The control method according to claim 7, wherein in the brake-shift integrated system based on machine-hydraulic compound, the power distribution module comprises a gear ring, a planetary carrier, a sun wheel, a first brake and a second brake, wherein the planetary carrier is connected to a gearbox case via the first brake and to the gear ring via the second brake, which is connected to the shift motor; the planetary carrier is also connected to the solar wheel, which is connected to the brake motor.

16. The wire-controlled vehicle according to claim 10, wherein in the brake-shift integrated system based on machine-hydraulic compound, the shift booster mechanism is provided with a first cavity and a second cavity, wherein the first cavity and the second cavity are interconnected, the first cavity is provided with a valve body, and the second cavity is provided with a shift booster piston; the first cavity is provided with three channels at an upper end and two channels at a lower end; the three channels at the upper end form a high-pressure oil circuit and a low-pressure circuit at left and right ends; the high-pressure oil circuit is in communication with the high-pressure accumulator, and the low-pressure circuit at the left and right ends is in communication with the oil storage cylinder; the two channels at the lower end are connected to two shift booster cylinders in the second cavity; the valve body and the shift booster piston are fixed to the shift fork.

17. The wire-controlled vehicle according to claim 10, wherein in the brake-shift integrated system based on machine-hydraulic compound, a surface of the shift guide rail is provided with a high gear rail groove, a shift rail groove and a low gear rail groove, wherein the shift rail groove is connected to the high gear rail groove and the low gear rail groove by two sloping grooves at each end, and a connection is provided with a shift guide mechanism.

18. The wire-controlled vehicle according to claim 17, wherein in the brake-shift integrated system based on machine-hydraulic compound, the shift guide mechanism comprises a baffle and a reset spring, while the baffle is connected to the shift guide rail and a bottom end is restrained by the reset spring.

19. The wire-controlled vehicle according to claim 10, wherein in the brake-shift integrated system based on machine-hydraulic compound, the brake-by-wire module comprises a brake motor, a screw rod, a nut, a brake piston, a brake master cylinder and a solenoid valve group; the brake motor is fixed to one end of the screw rod, and an other end of the screw rod is connected to one end of the nut; an other end of the nut is connected to one end of the brake piston; an other end of the brake piston is connected to one end of the brake master cylinder; an other end of the brake master cylinder is connected to the solenoid valve group; the solenoid valve group comprises a booster solenoid valve, a pressure relief solenoid valve and a brake wheel cylinder.

20. The wire-controlled vehicle according to claim 10, wherein in the brake-shift integrated system based on machine-hydraulic compound, the power distribution module comprises a gear ring, a planetary carrier, a sun wheel, a first brake and a second brake, wherein the planetary carrier is connected to a gearbox case via the first brake and to the gear ring via the second brake, which is connected to the shift motor; the planetary carrier is also connected to the solar wheel, which is connected to the brake motor.
